(19) United States
(12) Patent Application Publication
(10) Pub. No.: US 2021/0192606 A1
(43) Pub. Date: Jun. 24, 2021

(54) Virtual Online Dressing Room

(71) Applicant: Richard Weiner, Merrick, NY (US)

(72) Inventor: Richard Weiner, Merrick, NY (US)

(21) Appl. No.: 16/994,321

(22) Filed: Aug. 14, 2020

Related U.S. Application Data
(60) Provisional application No. 62/861,593, filed on Jun. 14, 2019.

(51) Int. Cl. G06Q 30/06; G06K 9/00; G06Q 20/32; G06T 19/00

(52) U.S. Cl. CPC G06Q 30/0643; G06T 19/006; G06Q 20/326; G06K 9/00369

(57) ABSTRACT

A system for scanning a body to determine a body measurement data set for creation of a virtual avatar representative of a user's body. The system synthesizes a body-clothing image from clothing measurement data and the body measurement data. An avatar represents the real word user trying on or wearing the real-world clothing article. The system facilitates ordering or purchasing the real-world clothing article and facilitates sharing user data or user profile with other users.

### CROSS-REFERENCE TO RELATED APPLICATIONS

The present application is related to and claims priority to U.S. Provisional Patent Application No. 62/861,593 filed Jun. 14, 2019, which is entirely incorporated by reference.

### BACKGROUND

The following includes information that may be useful in understanding the present disclosure. It is not an admission that any of the information provided is prior art nor material to the presently described or claimed inventions, nor that any publication or document that is specifically or implicitly referenced is prior art.

Online shopping is a current, commonplace method of purchasing clothing. Trying on new clothing from online stores is impossible without visiting a retail location. It can be annoying to have to return clothing items purchased online because they do not look as good as the consumer thought they would. Going to the retail store and trying on clothing can be time-consuming and frustrating. It causes expenses such as gasoline and other travel costs and unnecessarily exposes a consumer to sicknesses. And having to return clothing items purchased online that may not look as good as one thought can be annoying.

Traditionally, users had to go to stores to shop for merchandise. Now users can also choose to view merchandise at various online web sites where merchandise can be viewed on hangers, shelves, models, manikins, and, even fairly recently, avatars. And now that consumers know they should avoid unnecessary contact with other people, online shopping is likely to increase.

As disclosed below, this system allows users to see the merchandise on their bodies, on themselves.

U.S. Pat. No. 10,628,666 A system for scanning a body to create scan data comprises a processor, a range camera capable of capturing at least a first set of depth images of the body rotated to 0 degrees, and at least a second set of depth images of the body rotated to x degrees, wherein x is >0 degrees, and x<360 degrees. a set of computer instructions are executable on a processor capable of synchronizing scan data and body measurements with a server.

US Pre-grant Publication No. 20140279289 discloses a mobile application which enables an online shopper to see how an item of clothing will look on them—simulating an actual trying-it-onsession in the dressing room—before purchasing it. The online shopper downloads the TRY IT ON—ONLINE™ mobile application to his or her mobile communications device. Once the shopper has downloaded the mobile application to his or her mobile communications device, a series of prompts ask the shopper for information about their size, body shape, and skin tone. Once the screens are populated with this information, the mobile application guides the shopper through their online shopping excursion, and, like a personal shopper, helps them select an article of clothing that will fit and flatter their body shape. Before purchasing the item, the shopper can try it on virtually just as if they were in a dressing room at the store.

U.S. Pat. No. 9,183,581 discloses a virtual-outfitting interface which may be provided for presentation to the user. An item-search

U.S. Pat. No. 9,646,340 discloses a method to help a user visualize how a wearable article will look on the user's body. Enacted on a computing system, the method includes receiving an image of the user's body from an image-capture component. Based on the image, a posable, three-dimensional, virtual avatar is constructed to substantially resemble the user. In this example method, data is obtained that identifies the wearable article as being selected for the user. This data includes a plurality of metrics that at least partly define the wearable article. Then, a virtualized form of the wearable article is attached to the avatar, which is provided to a display component for the user to review.

US Pre-grant Publication No. 20020021297 discloses a system for displaying garments on a computer-rendered three-dimensional mannequin, comprising (A) a computer-rendered model of a person, the model being three-dimensional and rotatable; (B) a size selection control, for selecting one of a plurality of sizes, the sizes to be applied to the model; (C) a proportion selection control for selecting one of a plurality of proportions, a selected one of the proportions to be applied to the model; and (D) a garment selection control for selecting one of a plurality of garments, a selected one of the garments to be displayed on the model.

US Pre-grant Publication No. 20140035913 discloses a method and system to facilitate recognition of gestures representing commands to initiate actions within an electronic marketplace on behalf of a user. Spatial data about an environment external to a depth sensor may be received by an action machine. The action machine may generate a first model of a body of the user based on a first set of spatial data received at a first time. The action machine may then generate a second model of the body of the user based on a second set of spatial data received at a second time. The action machine may further determine that a detected difference between the first and second models corresponds to a gesture by the user, and that this gesture represents a command by the user to initiate an action within the electronic marketplace on behalf of the user.

US Pre-grant Publication No. 20170236334 discloses a virtual fitting system, comprising a virtual fitting device configured to provide a virtual scene where a user tries on a sample garment prototype and a sample garment; and a modification unit configured to modify, in response to a request of the user, the sample garment prototype on which the user tries to generate a sample garment that meets the requirements of the user. The virtual fitting system can implement customization of personalized garments. Also provided are a virtual fitting device and a virtual fitting method.

### SUMMARY

The present invention provides users with a system and a software program functioning as a virtual try-on system for clothing and accessories, enabling users to sample digital clothing and outfits on their bodies. Effectively, the system allows users to scan their entire body and upload the image into the application for trying on garments from retail stores, online retailers, and more. The system records hundreds of body measurements of the user such as height, arm and leg length, inseam, chest, hip, waist, and more, maximizing accuracy when trying on specific sizes and styles of clothing, and enabling users to see how the outfit will look through their digital avatar when walking, sitting, walking up and down stairs, and various other movements. The use of the system can prevent users from buying clothing and outfits online that do not fit properly, look unsightly or awkward, and more.

The disclosed system uses a method to prepare a graphical representation of measurement data of a real-world clothing article combined with measurement data from a real-world user's body. The method comprises supplying client software running on a client device. The client software facilitates recording real-world body measurement data of the user and transmitting the body measurement data to a server. With this or separately, the method includes identifying a virtual representation of a real-world clothing article and transmitting the information about the real-well clothing article to a server. The method also has a step of the client software receiving a graphical representation of the measurement data from the real-world clothing article juxtaposed with the real-world body data. In some versions, the client device comprises a measurement module, such as a hardware or software module. Recording can include receiving laser energy, acoustic energy, or light, depending upon which version of the method is employed. This energy carries information regarding the real-world body measurements and can be recorded using the measurement module. In some versions, the measurement module transmits laser, electromagnetic, or acoustic energy.

Some method versions use a server with the client. These types of methods further comprise a step of supplying server software that processes receiving the real-world body measurement data, receiving identifying information about the clothing article, determining real-world measurement data from the clothing article based on the clothing article identifying information, generating an avatar based on the real-world body measurement data, synthesizing an image representing a graphical juxtaposition of the clothing article measurement data and the body measurement data, and transmitting the image to the client. In some versions, the server software processes purchasing transactions, processes fulfillment transactions, or both. In some versions, determining real-world clothing article measurements comprises querying one or more clothing databases in which the clothing databases are local or remote to the server. In some versions, local clothing databases are maintained by a processor of the server.

The client device can be a smartphone. System software sometimes facilitates image data sharing with other users and facilitates purchasing the clothing article, as desired.

### BRIEF DESCRIPTION OF THE DRAWINGS

The figures that accompany the written portion of this specification illustrate embodiments and methods of use for the system of the present disclosure.

FIG. 1 depicts a user with a client device.

FIG. 2 depicts an avatar.

FIG. 3 depicts a user interface screen of the client device.

FIG. 4 depicts a draped avatar displayed on the client device.

FIG. 5 depicts another draped avatar displayed on the client device.

FIG. 6 depicts another user interface screen of the client device.

FIG. 7 depicts a schematic representation of a server.

FIG. 8 depicts a schematic representation of a client.

Various versions of the present invention will be described with the appended drawings, wherein like designations denote like elements.

### DETAILED DESCRIPTION

### Component Numbers

| | |
|---|---|
| user | 10 |
| electronic device | 20 |
| garment thumbnail | 40 |
| user interface screen I | 131 |
| user interface screen II | 133 |
| user interface screen III | 134 |
| avatar | 200 |
| draped avatar I | 210 |
| draped avatar II | 220 |
| representative measurement data | 250 |
| server, server device | 1000 |
| server-side software | 1010 |
| processor | 1020 |
| server-side communications module | 1030 |
| avatar processor module | 1040 |
| synthesizer, synthesizer module | 1070 |
| clothing database | 1200 |
| client, client device | 2000 |
| client-side software | 2010 |
| processor | 2020 |
| client-side communications module | 2030 |
| user interface | 2040 |
| display screen | 2050 |
| body scanning module | 2060 |

In the context of the present specification, a “server” is a computer program that is running on appropriate hardware (the hardware itself, for discussion convenience). The hardware can receive queries or requests (e.g., from client devices) over a network, and carry out or cause those requests to be carried out. The hardware may be a physical computer or more than one physical computer system, as desired. In the present context, the use of the expression a “server” is not intended to mean that every task (e.g., received instructions or requests) or any particular task will have been received, carried out, or caused to be carried out, by the same server (i.e., the same software or hardware combination). Any number of software elements or hardware devices may be involved in receiving, sending, carrying out, or causing to be carried out any task, request, or the consequences of any task or request. In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets. A device acting as a client device in the present context may act as a server to other client devices. The use of the expression “a client device” does not preclude multiple client devices, as discussed above, for the server device. A “database” is any structured collection of data, irrespective of its particular structure, the database management software, or the computer hardware on which the data is stored, implemented, or otherwise rendered available for use. A database may reside on the same hardware as the process that stores or makes use of the information stored in the database, or it may reside on separate hardware, such as a dedicated server or plurality of servers. The expression “information” includes information of any nature or kind whatsoever capable of being stored in a database. Thus, information includes audiovisual works (images, movies, sound records, presentations, etc.), data (location data, numerical data, etc.), text (opinions, comments, questions, messages, etc.), documents, spreadsheets, word lists, etc. The expression “component” is meant to include software (appropriate to a particular hardware context) that is both necessary and sufficient to achieve the referenced function or functions.

The words “first”, “second”, “third”, etc. have been used as adjectives only for allowing for the distinction between the nouns that they modify and not to describe any particular relationship between those nouns. Thus, for example, the use of the terms “first item” and “third item” doesn't imply any particular order, type, chronology, hierarchy or ranking (for example) of or between the items, nor does their use (in and of itself) imply that any “second item” must exist in any given situation. Reference to a “first” element and a “second” element does not preclude the two elements from being the same actual real-world element. For example, a “first” server and a “second” server may be the same software or hardware; in other cases, they may be different software or hardware.

The examples and conditional language are intended to aid the reader in understanding the present technology and not to limit its scope to those specifically recited examples and conditions. Those skilled in the art may devise various arrangements that, although not explicitly described or shown, nonetheless embody the present technology and are included within its spirit and scope.

To aid understanding, this discussion may describe simplified implementations of the present technology. Various implementations of the present technology may exhibit greater complexity.

Moreover, all statements reciting principles, aspects, and implementations of the present technology, as well as specific examples of the technology, are intended to encompass both structural and functional equivalents of the technology, whether they are currently known or developed in the future. Any block diagrams represent conceptual views of illustrative circuitry or connectivity embodying the principles of the present technology. Any flowcharts, flow diagrams, state transition diagrams, pseudo-code, etc. represent processes that may be executed by a computer or processor or that may be represented in computer-readable media, whether such computer or processor is shown.

Dedicated hardware or hardware capable of executing appropriate software that may provide the functions of the various elements shown in the figures, including any functional block labeled as a “processor” or a “graphics processing unit”. When a processor provides the functions, it may be a single dedicated processor, a single shared processor, or multiple individual processors, some of which may be shared. The processor may be a general-purpose processor, such as a central processing unit, or a processor dedicated to a specific purpose, such as a graphics processing unit. The term “processor” or “controller” does not exclusively refer to hardware capable of executing software, and may include, without limitation, conventional or custom digital signal processor hardware, network processor, application-specific integrated circuit, field-programmable gate array, read-only memory for storing software, random access memory, and non-volatile storage.

Software modules, or simply modules, that are by implication, software, may be represented as any combination of flowchart elements or other elements indicating the performance of process steps or textual description. These modules may be executed by hardware, whether shown or not. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components, in example configurations, may be implemented as a combined structure or component. Similarly, structures and functionality presented as a single component may be implemented as separate components.

Certain embodiments are described as including logic or several components, modules, or mechanisms. Modules may constitute either software or hardware modules. A “hardware module” is a tangible unit capable of performing certain operations and may be configured or arranged in a specific physical manner.

In some embodiments, a hardware module may be implemented mechanically or electronically, or implemented using a mechanical-electrical hybrid. For example, a hardware module may include dedicated circuitry or logic that is permanently configured to perform certain operations. Examples of these permanently configured devices include a special-purpose processor, such as a FPGA or an ASIC. A hardware module may also include programmable logic or circuitry that is temporarily configured by software to perform certain operations. For example, a hardware module may include software encompassed within a general-purpose processor or other programmable processors. The decision to implement a hardware module mechanically, in dedicated and permanently configured circuitry or temporarily configured circuitry (e.g., configured by software) may be driven by cost and time considerations.

Accordingly, the phrase “hardware module” encompasses a tangible entity, be that an entity that is physically constructed or permanently or temporarily configured (e.g., hardwired or programmed) to operate in a particular manner or to perform certain operations. “Hardware modules” encompasses “hardware-implemented modules” that are temporarily configured (e.g., programmed). Not all hardware modules need to be configured or instantiated at any one instance. For example, where a hardware module comprises a general-purpose processor configured by software to become a special-purpose processor, the general-purpose processor may be differently configured as different special-purpose processors (e.g., comprising different hardware modules) at different times. The software may accordingly configure a processor, for example, to constitute a particular hardware module at one instance of time and to constitute a different hardware module at another instance of time.

Hardware modules can provide information to and receive information from other hardware modules. Accordingly, “communicatively coupled” means that multiple hardware modules exist (at different or the same times) that may exchange signal transmissions (e.g., over appropriate circuits and buses).

The various methods may be performed, at least partially, by one or more processors that are temporarily configured (e.g., by software) or permanently configured to perform the relevant operations. Whether temporarily or permanently configured, such processors may constitute processor-implemented modules that operate to perform one or more described operations or functions. A “processor-implemented module” is a hardware module implemented using one or more processors.

Similarly, the described methods may be at least partially processor-implemented, a processor being an example of hardware. For example, at least some of the operations of a method may be performed by one or more processors or processor-implemented modules. And one or more processors may act with or in concert with a “cloud computing” environment.

The performance of certain of the operations may be distributed among one or more processors, not only those residing within a single machine but those deployed across several machines. Sometimes, the one or more processors or processor-implemented modules are co-located (e.g., within a home environment, an office environment, or a server farm). And sometimes, the one or more processors or processor-implemented modules are geographically distributed.

Unless explicitly stated otherwise, words such as “processing”, “computing”, “calculating”, “determining”, “presenting”, “displaying”, or the like refer to actions or processes of a machine (e.g., a computer) that manipulates or transforms data represented as physical (e.g., electronic, magnetic, or optical) quantities within one or more memories (e.g., volatile memory, non-volatile memory, or any suitable combination of memories), registers, or other machine components that receive, store, transmit, or display information. The conjunction “or” refers to a non-exclusive “or” unless expressly stated otherwise.

For purposes of this disclosure, the following terms have the following meanings. An “avatar” is a virtual representation of a real-world body or human body. “Body-clothing images” are images in which an accurate representation of a real-world clothing article is draped over an avatar. A “Client-server session” start when the client initiates a new connection with the server and ends when the client terminates the connection with the server. “Client software” is software that runs on a client device. “Real-world” means that the object physically exists and can be measured.

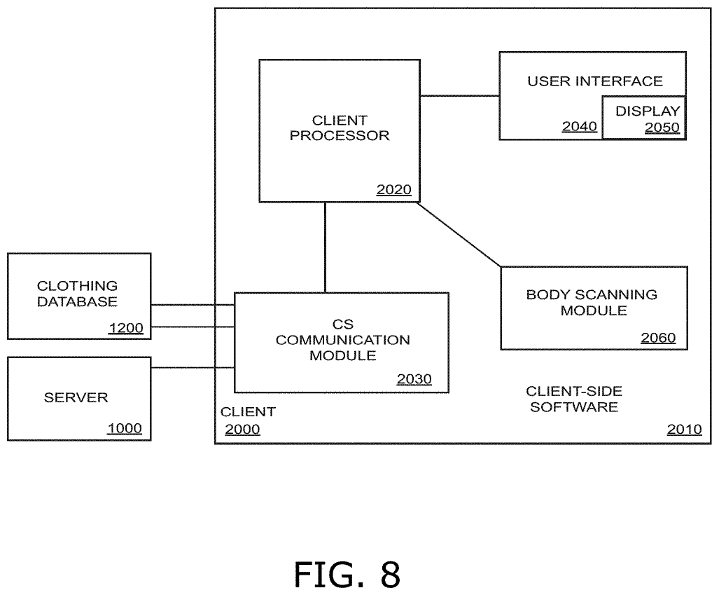

“Purchasing transactions” are any transactions that are involved in conducting a purchase. In some cases, a purchasing transaction is initiated on the client. “Fulfillment transactions” are any transactions that contribute to shipping the item to a purchaser. In some cases, fulfillment transactions are initiated on the server. “Clothing databases” are databases that contain information about multiple measurements of real-world clothing items. (See FIG. 8, element 1200).

### Mirror Image Dressing Room (MID)

The present system and software program function to-provide users with a virtual try-on system for clothing, enabling users to sample digital clothing and outfits on their body. In other words, the present system facilitates a virtual wardrobe with the capability to try on clothing virtually, but reliably, and to purchase the clothing should that become desired. In some versions, the user's virtual image or avatar is an accurate mirror-image of the user's real-world body because the avatar is constructed from scanned measurements of the user's real-world body. Effectively, the system allows users to scan their entire body and upload the image into the application for trying on garments from retail stores, online retailers, and more.

The system records hundreds of body measurements of the user such as height, arm and leg length, inseam, chest, hip, waist, and more, maximizing accuracy when trying on specific sizes and styles of clothing, and enabling users to see how the outfit will look through their digital avatar when walking, sitting, walking up and down stairs, and engaging in various other movements. The use of the system can prevent users from buying clothing and outfits online that do not fit properly, look unsightly or awkward, and more.

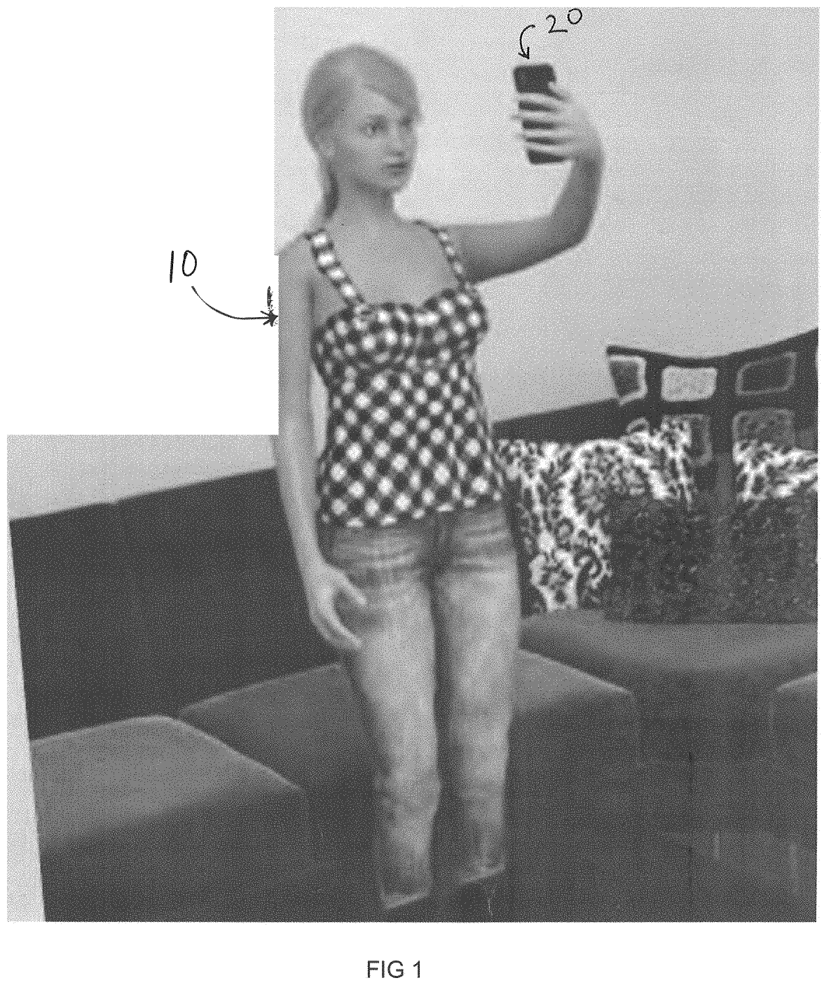

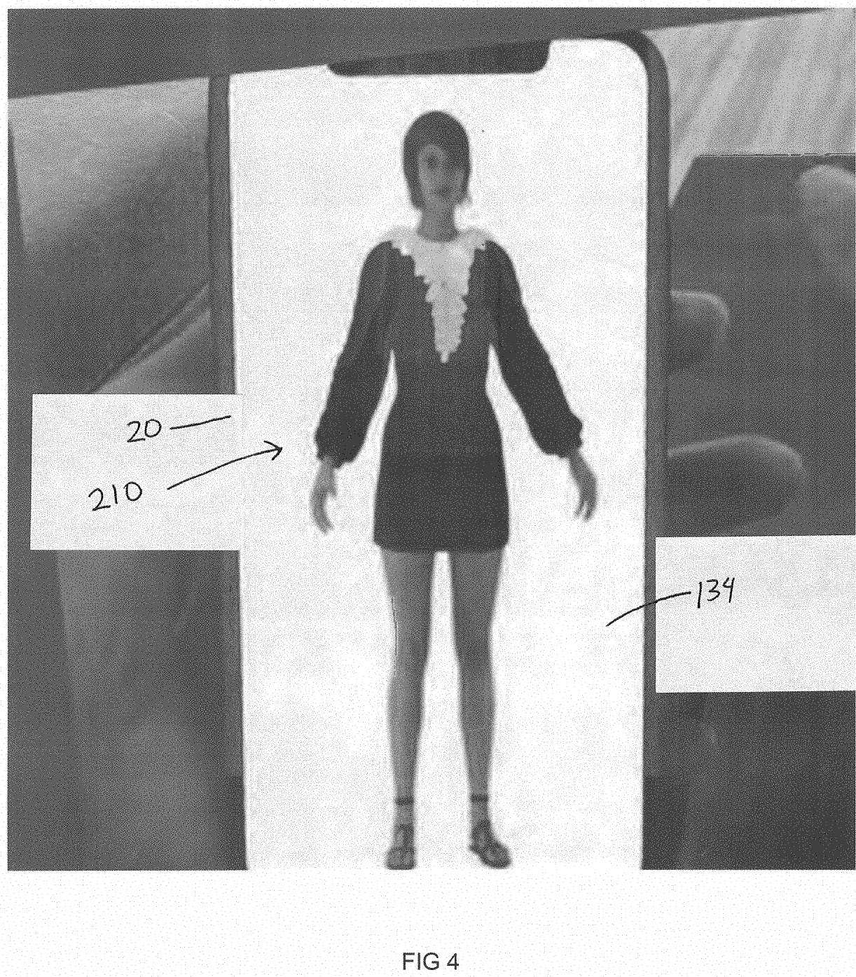

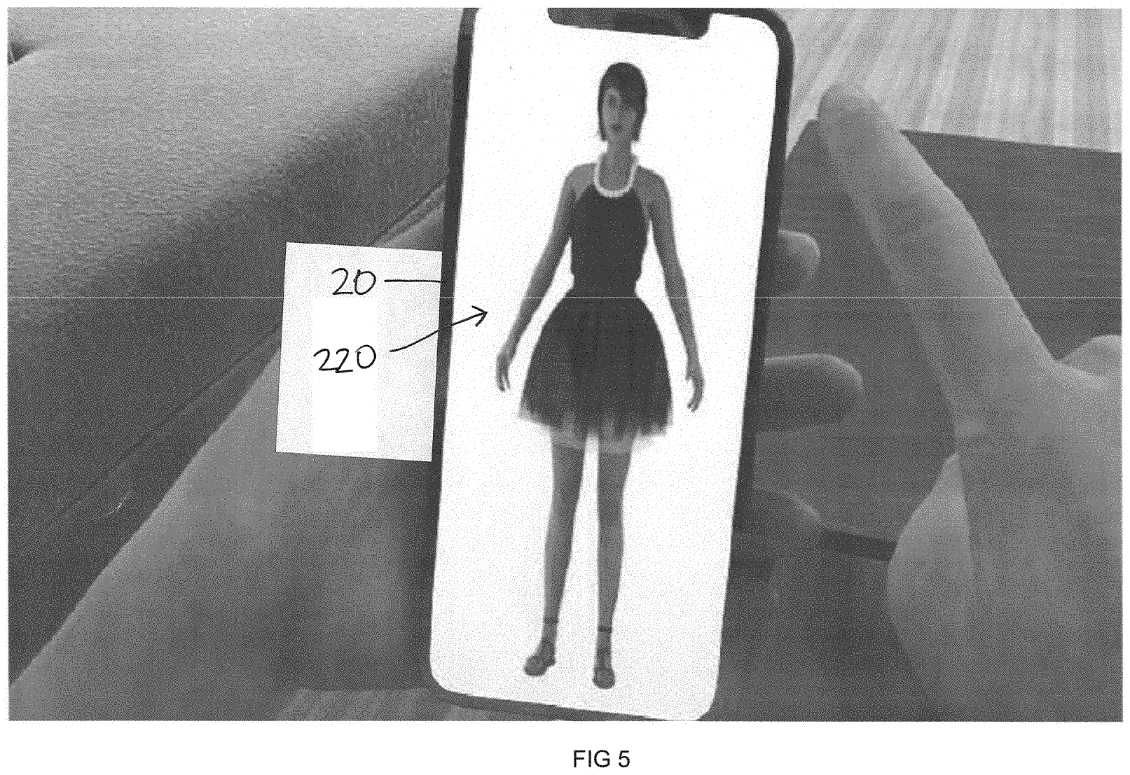

The system may include a software application that is accessible by a website or smartphone application. The system may capture a body of a user using video, scanners, imaging systems, etc. that will record body measurements. (see FIG. 1.) With this information, the system can apply or drape an item of clothing onto a user's body using a virtual reality system, allowing the user to visualize the item on their body. (See FIGS. 4 and 5.) In some versions, the system uses the body measurement data to search for available clothing filtered by the user's taste and aesthetic.

The application enables users to create custom profiles, upload full-body scans, and try on clothing virtually or online. The custom profile can store any amount of related information about the user, their wardrobe, and their body measurement data. The system operates by capturing a user's exact body image. Once the digital representation of the user's body is accurately constructed (a digital avatar is created), the user can then begin trying on clothing. Clothing can be selected from various retail stores and online retailers and applied to the digital avatar. Users can try on clothing before purchasing it online or in-person at a store. Specific clothing and outfits can be downloaded and saved to the custom profile for future viewing or purchasing. Tapping into regularly updated retail or clothing databases allows the application to provide close to real-time clothing availability. The app also allows users to share profiles with others for opinions and gift-giving opportunities. Since the full-body scans are not cumbersome, users can maintain up-to-date body dimensions that have changed for any number of reasons, including weight gain or loss, body changes due to natural aging, hair color, etc.

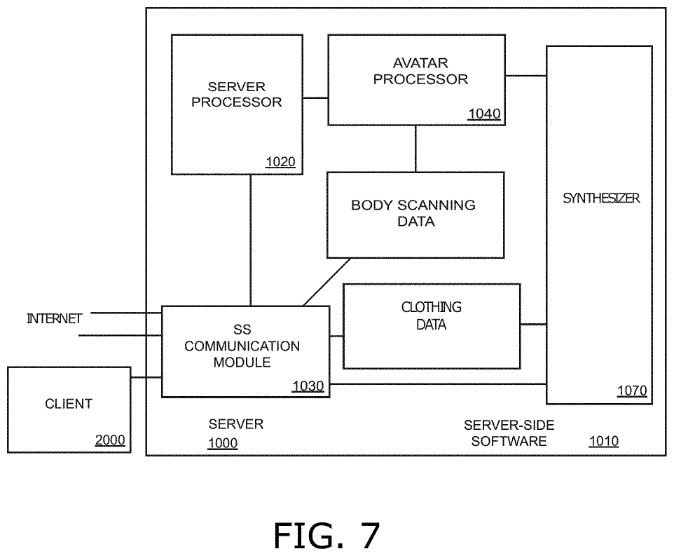

As shown in FIGS. 7 and 8, the system has various functionality split between a user device, client device 2000, or client device 2000 and server or server device 1000. Client device 2000 has the functionality to conduct a body scan, record the data for numerous measurements, and transmit that body measurement data to server 1000. In some versions, the system records hundreds of body measurements taken from positions 360 degrees around the user.

Client device 2000 also functions to display clothing from online retailers allowing users to shop from home. Client device 2000 comprises a user interface that allows the user to operate the functionality of the MID system. For instance, in some versions, the user interface includes controls to show-it-on-me-now, which trigger the display of the user's avatar draped with the selected clothing article. Similarly, in some versions, the user interface includes controls to buy-it-now to complete the purchase and fulfillment (delivery) of the selected clothing article.

Server device 1000 has the functionality to receive body measurement data from client device 2000 over an electronic network. Server device 1000 also has the functionality to receive identifying data about the specific clothing article the user wishes to preview and has connectivity to retrieve measurement data about that clothing article. Once server device 1000 has body measurement data, server device 1000 generates an avatar representing the shape of the user's body. When combined with data about the particular item of clothing, server device 1000 synthesizes an image of the item on the user's body; the representation is accurate because many measurements of the user's body and many measurements of the article are juxtaposed by synthesizer module 1070. Creating avatar 200 and using many measurements of the clothing article allows server device 1000 to match the clothing article to the virtual body to create a synthesized clothing-body virtual construct. Server device 1000 transmits the image data representing the virtual construct to client device 2000.

In some versions of the MID system, client device 2000 is electronic device 20. Client device 2000 comprises a processor 2020, a user interface 2040 (with the display screen 2050), computer memory (not shown), a client-side communications module 2030, a battery (not shown), and a body scanning module 2060. Client-side software 2010 operates or facilitates control over these components.

Server 1000 comprises a processor 1020, computer memory (not shown), a server-side communications module 1030, an avatar processor module 1040, and image synthesizer 1070. Server-side software 1010 operates or facilitates control over these components.

### Point of View of User

FIG. 1 depicts a user with electronic device 20 version of client 2000. Electronic device 20 can be a special-purpose device or can be a general-purpose device running software to create a special-purpose device or special functionality. In some versions, electronic device 20 is a cell phone or smartphone. Electronic device 20 in concert with server-side software 1010 can systematically collect measurement data about the user's body. For instance, in some versions, electronic device 20 uses a laser scanner, a camera, an acoustic receiver or transmitter, or some other electromagnetic transmitter or receiver to form body scanning module 2060 to determine or record the measurements.

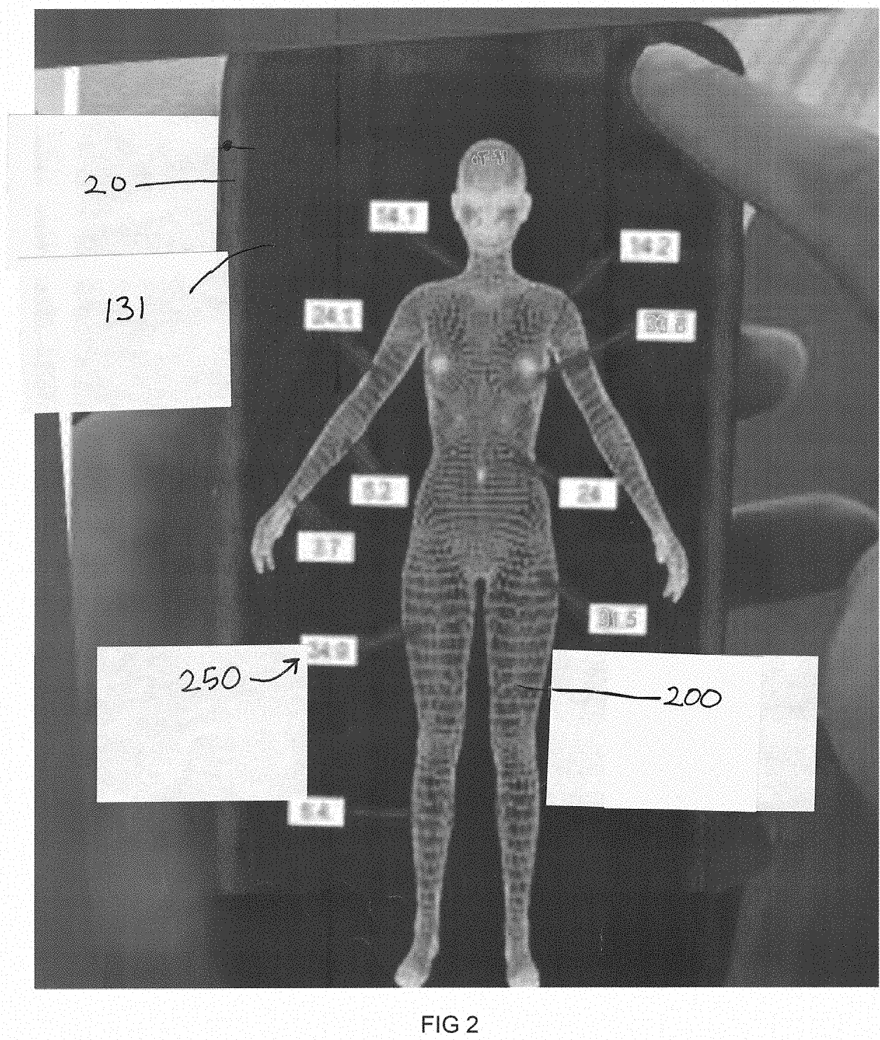

FIG. 2 represents an avatar 200 created from the body measurement data. Electronic device 20 displays the avatar using a first screen of the user interface, user interface screen I, element 131. FIG. 2 also shows representative measurement data 250 at multiple points around the user's body. A user scans their body with electronic device 20 and then views an image of an avatar 200 that represents the user's body. Viewing and scanning are controlled through the user interface created by client-side software 2010. In addition to body measurement data represented by avatar 200, MID functionality uses a particular garment selected by the user.

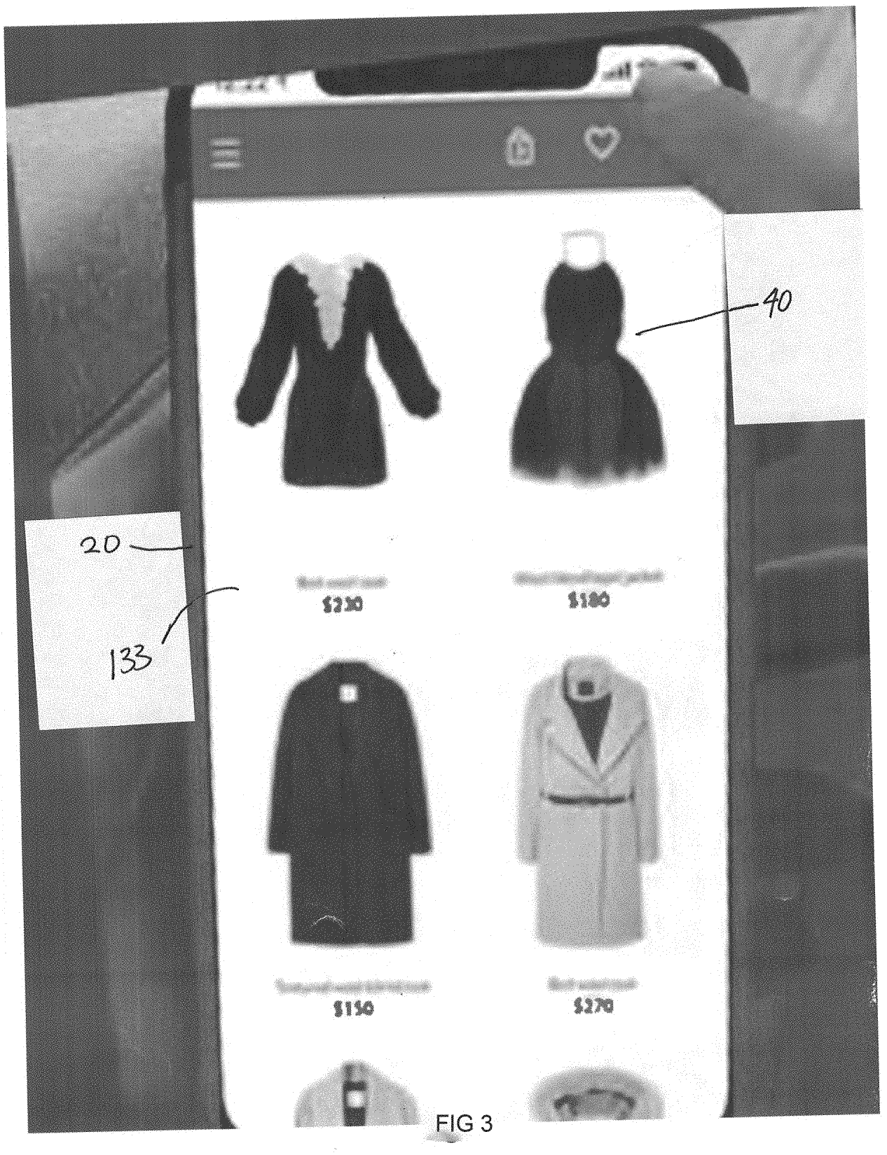

FIG. 3 shows electronic device 20 displaying a product or garment thumbnail 40 using user interface screen II, element 133. These garment thumbnails 40 can come from virtually any manufacturer and allow an initial look at the garment before the garment is draped onto avatar 200. Electronic device 20 sends data regarding the selection to server 1000. After server 1000 processes the data and synthesizes the image, electronic device 20 receives the synthesized image data: a representation of the clothing article on the user's body. This image graphically represents the match between the user's body measurement data and the garment's garment measurement data.

FIG. 4 depicts electronic device 20 using user interface screen III 134 to display a first draped avatar 210. Likewise, FIG. 5 represents electronic device 20 displaying a second draped avatar 220 showing the user wearing a different garment. Both of these draped images represent the similarities and differences between the user's real-world body measurements and each garment's real-world sizes. In some versions, the system uses the user's body measurement data to match an existing garment with the user.

Once the user is satisfied with the garment, the user interface allows the user to instruct electronic device 20 to send signals to purchase the clothing article. In some versions, the virtual clothing article is constrained by the specific measurements created during the garment manufacturer's manufacturing process. Thus, the system allows the user to “try-on” real garments on the user's real body remotely, yielding a Mirror-Image Dressing room with functionality mimicking a real-world dressing room.

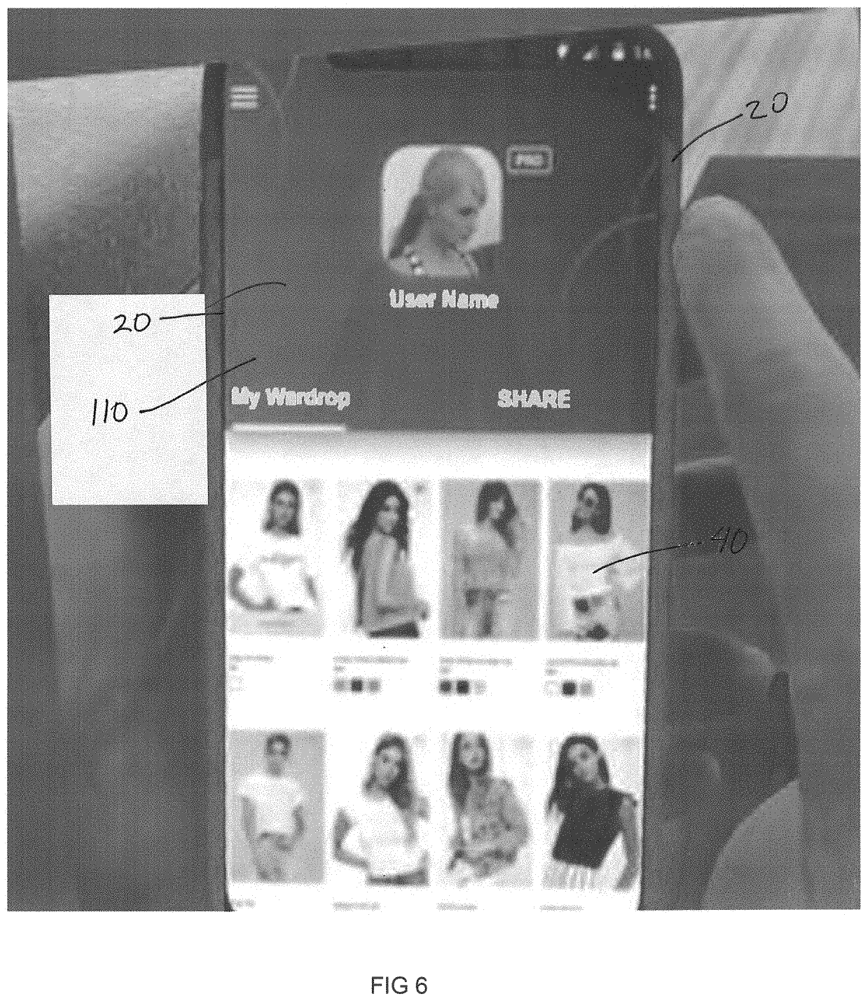

FIG. 6 represents the user interface of electronic device 20 showing functionality to share, among other information, image data with other users.

### Point of View of the System Processors

In some versions, the overall process is as follows. User 10, through the user interface to electronic device 20, causes electronic device 20 to initiate a session with server 1000. At some point during this session, user 10, through the user interface, causes electronic device 20 to create a measurement session in which the body scanner module of electronic device 20, hardware, software, or both, measures various dimensions of the user's real-world body. This data is saved locally or saved in a user account on server 1000. At some other time during the session, user 10 causes electronic device 20 to send queries to the retailer or clothing databases connected to the Internet, and electronic device 20 receives the results of those queries and displays graphical representations of the clothing articles available for use or purchase in the MID room system. At some point during the session, in some versions, electronic device 20 transmits information identifying the clothing article, clothing article ID information, to server 1000 and transmits body measurement data. Concurrent with the clothing articles transmission or at a different time, electronic device 20 transmits the body measurement data. Server 1000, running server-side software 1010, receives body measurement data and processes the body measurement data in avatar processor module 1040. And sometimes separately, server 1000 receives measurement data related to the clothing article ID information supplied by client 2000. The body measurement data and the clothing measurement data feed synthesizer 1070, which prepares an image that allows the user to graphically compare a set of measurements associated with the clothing article to the set of measurements associated with the user's body. This comparison is in the form of a body avatar draped with the clothing article. Once synthesizer 1070 synthesizes the image or images, server 1000 transmits the image data to client 2000, at which time, client 2000 displays the graphical representation of the measurements on a display screen, such as the display screen of electronic device 20. Client 2000 stores the image data locally, in some versions. Client 2000 provides the ability for the user to transmit instructions to purchase the clothing article should the measurements of the user's body sufficiently match measurements of the clothing article.

In most cases, “sufficiently matches” means that the measurements match well enough to be aesthetically pleasing to the user. Ancillary functionality for server 1000, such as order fulfillment, clothing database storage, and payment processing, are part of or are separate from server 1000 depending upon the version desired for the system. Likewise, alternatives exist for storing body measurement data. For instance, body measurement data is stored on client 2000 (electronic device 20), locally, or on the server associated with the user's account. Or body measurement data is not stored outside of the current client-server session; the server or client discards the data after the client-server session ends.

What is claimed is:

1. A method comprising supplying client software to run on a client device that facilitates
recording real-world body measurement data of a user;
transmitting the body measurement data to a server;
identifying a virtual representation of a real-world clothing article;
transmitting identifying information about the real-world clothing article to a server;
and
receiving a graphical representation of measurement data of the real-world clothing article juxtaposed with the real-world body data.

2. The method of claim 1, wherein the client device comprises a measurement module.

3. The method of claim 2, wherein recording includes receiving laser energy, acoustic energy, or light that carries information regarding real-world body measurements using the measurement module.

4. The method of claim 3, wherein the measurement module transmits laser, electromagnetic, or acoustic energy.

5. The method of claim 4 further comprising supplying server software that processes
receiving the real-world body measurement data;
receiving identifying information about the clothing article;
determining real-world clothing article measurement data;
generating an avatar based on the real-world body measurement data;
synthesizing an image representing a graphical juxtaposition of the clothing article measurement data and the body measurement data;
and
transmitting the image to the client.

6. The method of claim 5, wherein the server software further processes purchasing transactions.

7. The method of claim 6, wherein the server software further processes fulfillment transactions.

8. The method of claim 7, wherein determining real-world clothing article measurements comprises querying one or more clothing databases.

9. The method of claim 8, wherein the clothing databases are maintained by a processor of the server.

10. The method of claim 9, wherein the client device is a smartphone.

11. The method of claim 10, wherein the client software facilitates image data sharing with other users.

12. The method of claim 11, wherein the client software further facilitates purchasing the article of clothing.

13. The method of claim 5, wherein the server software further processes fulfillment transactions.

14. The method of claim 5, wherein determining real-world clothing article measurements comprises querying one or more clothing databases.

15. The method of claim 14, wherein the server software further processes purchasing transactions.

16. The method of claim 15, wherein the measurement module transmits laser, electromagnetic, or acoustic energy, and the client software facilitates image data sharing with other users.

17. The method of claim 5, wherein the server software further processes fulfillment transactions and determining real-world clothing article measurements comprises querying one or more clothing databases.

18. The method of claim 17, wherein the client software facilitates image data sharing with other users.

19. The method of claim 1 further comprising supplying server software that processes
receiving the real-world body measurement data;
receiving identifying information about the clothing article;
determining real-world clothing article measurement data;
generating an avatar based on the real-world body measurement data;
synthesizing an image representing a graphical juxtaposition of the clothing article measurement data and the body measurement data;
and
transmitting the image to the client.

20. A method comprising supplying server software that processes
receiving real-world body measurement data;
receiving identifying information about a clothing article;
determining real-world clothing article measurement data;
generating an avatar based on the real-world body measurement data;
synthesizing an image representing a graphical juxtaposition of the clothing article measurement data and the body measurement data;
and
transmitting the image.
